(19) United States
(12) Patent Application Publication
(10) Pub. No.: US 2013/0147544 A1
(43) Pub. Date: Jun. 13, 2013

(54) REFERENCE VOLTAGE GENERATION CIRCUIT AND INTERNAL VOLATAGE GENERATION CIRCUIT USING THE SAME

(71) Applicants: Young Joo KIM, Hwaseong-si (KR); Jong Ho SON, Ichon-si (KR)

(72) Inventors: Young Joo KIM, Hwaseong-si (KR); Jong Ho SON, Ichon-si (KR)

(73) Assignee: HYNIX SEMICONDUCTOR INC., Ichon-si (KR)

(21) Appl. No.: 13/451,473

(22) Filed: Apr. 19, 2012

(30) Foreign Application Priority Data
Dec. 9, 2011 (KR) 10-2011-0131649

(51) Int. Cl. G05F 3/02

(52) U.S. Cl. 327/538; 323/313

(57) ABSTRACT

A reference voltage generation circuit configured to generate a reference voltage level that is compensated for based on an internal temperature change, where the reference voltage level is adjusted based on a resistance value controlled in response to a control signal.

### CROSS-REFERENCES TO RELATED APPLICATIONS

The present application claims priority under 35 U.S.C. 119(a) to Korean Application No. 10-2011-0131649, filed on Dec. 9, 2011, in the Korean intellectual property Office, which is incorporated herein by reference in its entirety set forth in full.

### BACKGROUND

Typically, a semiconductor memory device receives power supply voltage VDD and ground voltage VSS from an outside source, and generates and uses internal voltages required for internal operations. The internal voltages required for internal operations of the semiconductor memory device may include a core voltage VCORE supplied to a memory core area, a boosting voltage VPP used for driving or overdriving a word line, and a back bias voltage VBB supplied as a bulk voltage of an NMOS transistor of a memory core area.

Here, the core voltage VCORE may be supplied by lowering the power supply voltage VDD inputted from outside to a predetermined level. However, the boosting voltage VPP has a higher level than the power supply voltage VDD inputted from outside, and the back bias voltage VBB maintains a lower level than the ground voltage VSS inputted from outside. Therefore, charge pump circuits are needed to supply charges for the boosting voltage VPP and the back bias voltage VBB.

In general, internal voltages are generated by using a reference voltage. When an internal voltage has a lower level than the reference voltage, the internal voltage is driven by a power supply voltage or generated by pumping the internal voltage.

However, when the level of the reference voltage is changed by a PVT (Process, Voltage, Temperature) variation, temperature characteristics of the reference voltage may be changed according to an internal temperature change. Therefore, a temperature characteristic change of the reference voltage may have an effect upon the internal voltage, thereby causing an error in an operation of an internal circuit receiving the internal voltage.

### SUMMARY

An embodiment of the present invention relates to an internal voltage generation circuit capable of constantly maintaining the temperature characteristic of a reference voltage according to an internal temperature change by controlling the level of the reference voltage, thereby preventing an error from occurring in an operation of an internal circuit receiving an internal voltage, and an internal voltage generation circuit using the same.

In one embodiment, a reference voltage generation circuit configured to generate a reference voltage level that is compensated for based on an internal temperature change, where the reference voltage level is adjusted based on a resistance value controlled in response to a control signal.

In another embodiment, an internal voltage generation circuit includes: a reference voltage generation unit configured to control the level of a reference voltage in response to a control signal; a pad configured to monitor the reference voltage or apply a voltage to the reference voltage; and an internal voltage trimming unit configured to receive the reference voltage and generate first and second internal voltages trimmed at different levels.

In another embodiment, an internal voltage generation circuit includes: a reference voltage generation unit configured to control the level of a first reference voltage in response to a control signal; a buffer unit configured to buffer the first reference voltage and generate a second reference voltage; a pad configured to monitor the second reference voltage or apply a voltage to the second reference voltage; and an internal voltage trimming unit configured to receive the second reference voltage and generate first and second internal voltages trimmed at different levels.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram illustrating a configuration of an internal voltage generation circuit in accordance with an embodiment of the present invention;

FIG. 2 is a circuit diagram of a reference voltage generation circuit included in an internal voltage generation circuit illustrated in FIG. 1;

FIG. 3 is a circuit diagram of an internal voltage trimming unit included in the internal voltage generation circuit illustrated in FIG. 1;

FIG. 4 is a graph showing characteristic changes of a reference voltage generated by the reference voltage generation circuit of FIG. 2 depending on an internal temperature change of the reference voltage; and

FIG. 5 is a block diagram illustrating a configuration of an internal voltage generation circuit in accordance with another embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

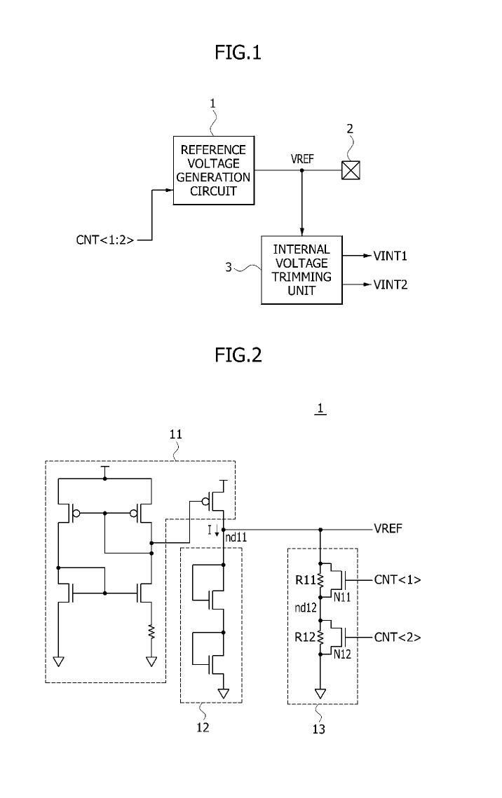

FIG. 1 is a block diagram illustrating a configuration of an internal voltage generation circuit in accordance with an embodiment of the present invention.

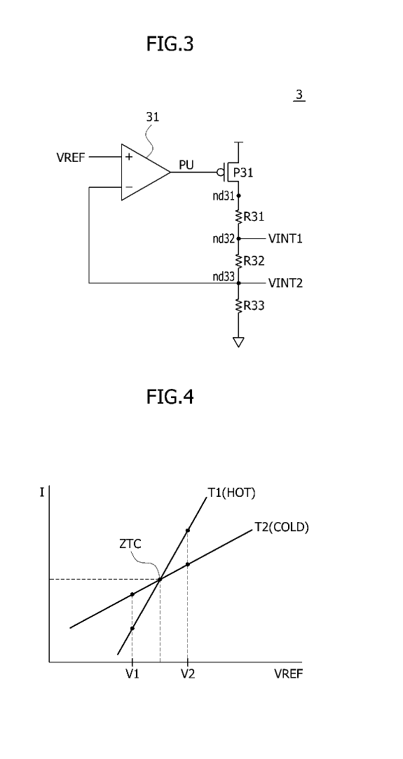

Referring to FIG. 1, the internal voltage generation circuit in accordance with an embodiment of the present invention includes a reference voltage generation unit 1, a pad 2, and an internal voltage trimming unit 3. The reference voltage generation unit 1 is configured to control a level of a reference voltage VREF in response to first and second control signals CNT<1:2>. The pad 2 is configured to output the reference voltage VREF for monitoring, and applying a voltage to the reference voltage VREF. The internal voltage trimming unit 3 is configured to receive the reference voltage VREF, and generate first and second internal voltages VINT1 and VINT2 trimmed at different levels. Hereafter, referring to FIGS. 2 and 3, configurations of the reference voltage generation unit 1, the pad 2, and the internal voltage generation unit 3 will be described in more detail as follows.

Referring to FIG. 2, the reference voltage generation unit 1 includes a current source 11, a first resistor section 12, and a second resistor section 13. The current source 11 may be implemented with a Widlar-type current source which includes MOS transistors and resistors having reverse current characteristics depending on an internal temperature change, and the current source 11 may generate a current I. The current I is outputted to a node nd11 from which the reference voltage VREF is outputted. The first resistor section 12 includes a plurality of diodes coupled between the first node nd11 and a ground voltage. The second resistor section 13 includes a resistor R11, an NMOS transistor N11, a resistor R12, and an NMOS transistor N12. The resistor R11 is coupled between the node nd11 and a node nd12. The NMOS transistor N11 operates as a switch element which is turned on to short the nodes nd11 and nd12 in response to the first control signal CNT<1>. The resistor R12 is coupled between the node nd12 and the ground voltage. The NMOS transistor N12 operates as a switch element which is turned on to short the node nd12 to the ground voltage in response to the second control signal CNT<2>.

The level of the reference voltage VREF generated by the reference voltage generation unit 1 configured in such a manner decreases when the resistance value of the second resistor section 13 is increased according to the first and second control signals CNT<1:2>, and increases when the resistance value of the second resistor section 13 is decreased.

Referring to FIG. 3, the internal voltage trimming unit 3 includes a PMOS transistor P31, a resistor R31, a resistor R32, a resistor R33, and a comparator 31. The PMOS transistor P31 operates as a driver configured to drive a node nd31 in response to a pull-up signal PU. The resistor R31 is coupled between the node nd31 and a node nd32 from which the first internal voltage VINT1 is outputted. The resistor R32 is coupled between the node nd32 and a node nd33 from which the second internal voltage VINT2 is outputted. The resistor R33 is coupled between the node nd33 and a ground voltage. The comparator 31 is configured to generate a pull-up signal PU which is enabled to a logic low level when the second internal voltage VINT2 has a lower level than the reference voltage VREF.

The internal voltage trimming unit 3 configured in such a manner generates the first and second internal voltages VINT1 and VINT2 having levels that are controlled according to the reference voltage VREF. That is, the voltage levels of the first and second internal voltages VINT1 and VINT2 increase when the voltage level of the reference voltage VREF is increased, and voltage levels of the first and second internal voltages VINT1 and VINT2 decrease when the voltage level of the reference voltage VREF is decreased.

Operation of the internal voltage generation circuit configured in such a manner will be described as follows with reference to FIG. 4.

Turning now to FIG. 4, which illustrates a graph showing characteristic changes of a reference voltage generated by the reference voltage generation circuit of FIG. 2 depending on an internal temperature change of the reference voltage. First, a PVT variation may cause a reference voltage VREF increase from a level V1 to a level V2, which may cause a change in the temperature characteristic of the reference voltage VREF. That is, when the reference voltage VREF corresponds to level V1, the amount of the current I at a high temperature T1 is smaller than at a low temperature T2. However, when the reference voltage VREF corresponds to the level V2, the amount of the current I at the high temperature T1 is larger than at the low temperature T2. The temperature characteristic changes of the reference voltage VREF are reflected in the first and second internal voltages VINT1 and VINT2, thereby causing an operation error of the internal circuit. Therefore, the internal voltage generation circuit in accordance with an embodiment of the present invention decreases the voltage level of the reference voltage VREF by increasing the resistance value of the second resistor section 13 according to the first and second control signals CNT<1:2>.

Accordingly, when a PVT variation causes the reference voltage VREF to decrease from the level V2 to the level V1, the temperature characteristic of the reference voltage VREF is changed. That is, when the reference voltage VREF corresponds to the level V2, the amount of the current I at the high temperature T1 is larger than at the low temperature T2, but when the reference voltage VREF corresponds to the level V1, the amount of the current I at the high temperature T1 is smaller than the low temperature T2. The temperature characteristic changes of the reference voltage VREF are reflected in the first and second internal voltages VINT1 and VINT2, thereby causing an operation error of the internal circuit. Therefore, the internal voltage generation circuit in accordance with an embodiment of the present invention increases a level of the reference voltage VREF by reducing the resistance value of the second resistor section 13 according to the first and second control signals CNT<1:2> to maintain a reference voltage substantially near the zero temperature coefficient point (ZTC).

In short, the internal voltage generation circuit in accordance with an embodiment of the present invention may control a level of the reference voltage VREF according to the first and second control signals CNT<1:2> and maintain and/or adjust the temperature characteristic of the reference voltage depending on the internal voltage change. Therefore, temperature characteristics of the first and second internal voltages VINT1 and VINT2 may be maintained to substantially prevent an error in the operations of the internal circuits.

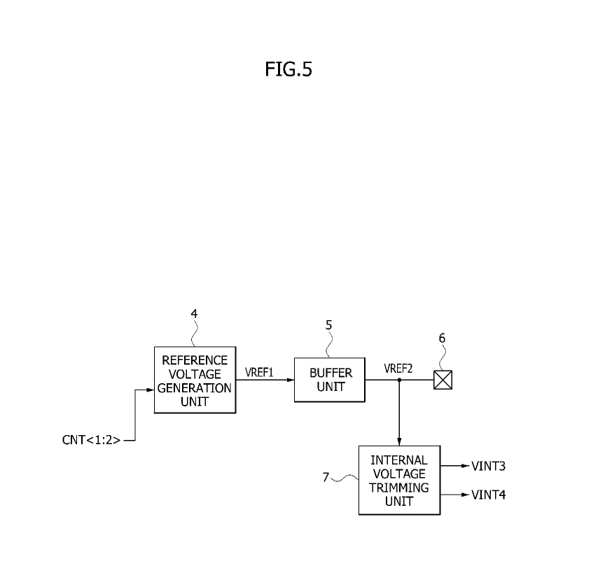

FIG. 5 is a block diagram illustrating the configuration of an internal voltage generation circuit in accordance with another embodiment of the present invention.

Referring to FIG. 5, the internal voltage generation circuit in accordance with an embodiment of the present invention includes a reference voltage generation unit 4, a buffer unit 5, a pad 6, and an internal voltage trimming unit 7. The internal voltage generation circuit in accordance with an embodiment of the present invention may include the buffer unit 5, which is not included in the reference voltage generation unit depicted in FIG. 1. The buffer unit 5 may be configured to buffer a first reference voltage VREF1 generated by the reference voltage generation unit 4 and generate a second reference voltage VREF2. The pad 6 outputs the second reference voltage VREF2 buffered through the buffer unit 5. Therefore, monitoring accuracy further increases.

In accordance with embodiments of the present invention, a levels of the reference voltages are controlled to constantly maintain temperature characteristics of the reference voltages depending on the internal temperature change, which makes it possible to substantially prevent an error from occurring in the operations of the internal circuits receiving the internal voltage.

The embodiments of the present invention have been disclosed above for illustrative purposes. Those skilled in the art will readily appreciate that various modifications, additions and substitutions are possible, without departing from the scope and spirit of the invention as disclosed in the accompanying claims.

What is claimed is:

1. A reference voltage generation circuit configured to generate a reference voltage level that is compensated for based on an internal temperature change, where the reference voltage level is adjusted based on a resistance value controlled in response to a control signal.

2. The reference voltage generation circuit of claim 1, further comprising:
a current source configured to generate a current by compensating for the internal temperature change and output the current to an output node where the reference voltage is generated;
a first resistor unit coupled between the output node and a ground voltage; and
a second resistor unit coupled in parallel to the first resistor unit between the output node and the ground voltage and having the resistance value controlled in response to the control signal.

3. The reference voltage generation circuit of claim 2, wherein the first resistor unit comprises one or more diodes.

4. The reference voltage generation circuit of claim 2, wherein the second resistor unit comprises:
a resistor coupled between the output node and a ground voltage; and
a switch element coupled in parallel to the resistor between the output node and the ground voltage and turned on in response to the control signal.

5. An internal voltage generation circuit comprising:
a reference voltage generation unit configured to control the level of a reference voltage in response to a control signal;
a pad configured to monitor the reference voltage or apply a voltage to the reference voltage; and
an internal voltage trimming unit configured to receive the reference voltage and generate first and second internal voltages trimmed at different levels.

6. The internal voltage generation circuit of claim 5, wherein the reference voltage generation unit comprises:
a current source configured to generate a current that is compensated based on an internal temperature change, and output the generated current to an output node where a reference voltage is generated;
a first resistor section coupled between the output node and a ground voltage; and
a second resistor section coupled in parallel to the first resistor section between the output node and the ground voltage and having a resistance value controlled in response to the control signal.

7. The internal voltage generation circuit of claim 6, wherein the first resistor section comprises one or more diodes.

8. The internal voltage generation circuit of claim 6, wherein the second resistor section comprises:
a resistor coupled between the output node and a ground voltage; and
a switch element coupled in parallel to the resistor between the output node and the ground voltage and turned on in response to the control signal.

9. The internal voltage generation circuit of claim 5, wherein the internal voltage trimming unit comprises:
a driver configured to drive a first node in response to a pull-up signal;
a first resistor coupled between the first node and a second node from which the first internal voltage is outputted;
a second resistor coupled between the second node and a third node from which the second internal voltage is outputted; and
a comparator configured to compare the second internal voltage with the reference voltage and generate the pull-up signal.

10. An internal voltage generation circuit comprising:
a reference voltage generation unit configured to control a level of a first reference voltage in response to a control signal;
a buffer unit configured to buffer the first reference voltage and generate a second reference voltage;
a pad configured to monitor the second reference voltage or apply a voltage to the second reference voltage; and
an internal voltage trimming unit configured to receive the second reference voltage and generate first and second internal voltages trimmed at different levels.

11. The internal voltage generation circuit of claim 10, wherein the reference voltage generation unit comprises:
a current source configured to generate a current that is compensating for based on an internal temperature change and output the current to an output node from which the first reference voltage is generated;
a first resistor section coupled between the output node and a ground voltage; and
a second resistor section coupled in parallel to the first resistor section between the output node and the ground voltage and having a resistance value controlled in response to the control signal.

12. The internal voltage generation circuit of claim 11, wherein the first resistor section comprises one or more diodes.

13. The internal voltage generation circuit of claim 11, wherein the second resistor section comprises:
a resistor coupled between the output node and a ground voltage; and
a switch element coupled in parallel to the resistor between the output node and the ground voltage and turned on in response to the control signal.

14. The internal voltage generation circuit of claim 10, wherein the internal voltage trimming unit comprises:
a driver configured to drive a first node in response to a pull-up signal;
a first resistor coupled between the first node and a second node from which the first internal voltage is outputted;
a second resistor coupled between the second node and a third node from which the second internal voltage is outputted; and
a comparator configured to compare the second internal voltage with the reference voltage and generate the pull-up signal.
